(19) United States
(12) Patent Application Publication
(10) Pub. No.: US 2018/0067613 A1
(43) Pub. Date: Mar. 8, 2018

(54) TOUCH-SENSITIVE DISPLAY DEVICE

(71) Applicant: Microsoft Technology Licensing, LLC, Redmond, WA (US)

(72) Inventor: Yingying Tang, Wilsonville, OR (US)

(73) Assignee: Microsoft Technology Licensing, LLC, Redmond, WA (US)

(21) Appl. No.: 15/260,032

(22) Filed: Sep. 8, 2016

(51) Int. Cl. G06F 3/041

(52) U.S. Cl. CPC G06F 3/0418; G06F 2203/04111; G06F 3/0412; G06F 3/0414

(57) ABSTRACT

Examples are disclosed herein that relate to touch and force sensing. One example provides a touch-sensitive display device comprising a transmit electrode array; a receive electrode array; a conductive plane configured such that the transmit and receive electrode arrays and the conductive plane resiliently deflect relative to one another in response to applied force; and a controller. The controller may be configured to (1) switch the conductive plane between a first electrical state and a second electrical state while causing a transmit electrode driver to drive the transmit electrode array, (2) receive a first output and a second output from the receive electrode array corresponding respectively to the first and second electrical states, and (3) determine a location of a touch input and an applied force of the touch input based on the first and second outputs.

### BACKGROUND

Various approaches to sensing touch input have been developed. In some implementations, a touch sensor is combined with a force sensor to provide both touch and force sensing at a common device such as a portable electronic device. The touch and force sensors may comprise respective capacitive sensing structures, for example.

### BRIEF DESCRIPTION OF THE DRAWINGS

FIG. 1 schematically shows an example touch-sensitive display device.

FIG. 2 shows a graph plotting various example datasets.

FIG. 3 shows a flowchart illustrating a method of input sensing.

### DETAILED DESCRIPTION

As described above, a variety of approaches to sensing touch input have been developed, some of which pair a touch sensor with a force sensor to enable both touch and force sensing at a common device (e.g., smartphone). The touch and force sensors may include respective capacitive sensing structures, for example. The inclusion of respective sensors for sensing touch and force, however, can increase the cost, complexity, and energy consumption of the device in which they are implemented. Other drawbacks may be associated with combined touch and force sensing, such as increased latency (e.g., between user input and resultant output). Further, force sensing may be limited to a limited number of touch locations (often, only one location), and an inability to accurately assess input object size (e.g., finger size) in the presence of varying applied force.

To address these and other issues, implementations of a touch-sensitive display device operable to sense touch and force input are disclosed herein. As described below, a common capacitive sensing structure may be used to sense, for multiple touch input locations, the XY location and the magnitude of the applied force, while minimizing latency, complexity, and consumption of processing resources. In many implementations, the concepts disclosed herein can also enable accurate calibration of the size of an input object.

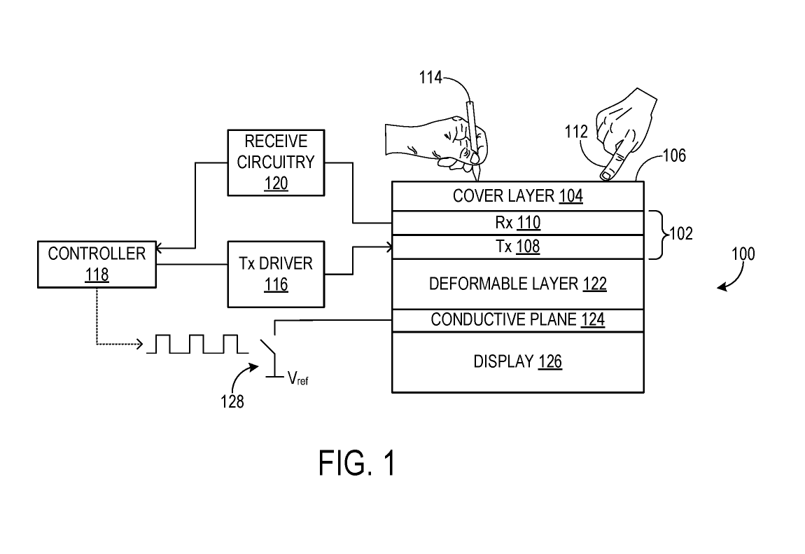

FIG. 1 schematically shows a touch-sensitive display device 100. Device 100 includes an electrode matrix 102 above which a cover layer 104 is positioned. Cover layer 104 may be formed from glass, plastic, or any other suitable material, and may protect display device 100 from debris and forces while providing a surface 106 to which touch inputs can be applied.

Electrode matrix 102 includes a transmit (Tx) electrode array 108 and a receive (Rx) electrode array 110. Tx electrode array 108 and Rx electrode array 110 may include a plurality of Tx electrodes and a plurality of Rx electrodes, respectively. In one example, Tx electrode array 108 and Rx electrode array 110 may be formed on two separate thin films as shown in FIG. 1, and may be bonded together by an optically clear adhesive (OCA) not shown in FIG. 1. Other arrangements are possible, however, including those in which Tx electrode array 108 and Rx electrode array 110 are respectively formed on opposite sides of a single substrate, and those in which Tx electrode array 108 and Rx electrode array 110 are formed on a single layer along with jumpers arranged to electrically isolate the Tx and Rx electrode arrays. Tx electrode array 108 and Rx electrode array 110 may be comprised of indium tin oxide (ITO), metal meshes, silver nanowires, or any other suitable materials.

As described in further detail below, electrode matrix 102 may be configured to aid in the determination of locations of one or more touch inputs and the force applied at each detected location of touch input. As examples, FIG. 1 shows input objects in the form of a human finger 112 and a stylus 114, whose locations and forces applied to surface 106 may be detected via electrode matrix 102. Electrode matrix 102 may facilitate the detection of alternative or additional input objects, including hover objects near but not in contact with surface 106.

To facilitate detection of touch input location and/or applied force, a Tx electrode driver 116 is coupled to Tx electrode array 108. A controller 118 is configured to cause Tx electrode driver 116 to drive Tx electrode array 108. In one example, Tx electrode driver 116 may sequentially apply AC voltages on a number of (e.g., each) Tx electrodes in Tx electrode array 108. Touch inputs may be detected based on resulting currents—e.g., that result from driving the Tx electrodes—induced on the Rx electrodes in Rx electrode array 110. The resulting currents may be received by receive circuitry 120, which is coupled to Rx electrode array 110 and may convert the currents into digital codes that can be provided to controller 118. Analysis of these digital codes may then take place to detect touch input location and/or applied force. Receive circuitry 120 may include current-to-digital converters coupled to each Rx electrode, for example.

As depicted, touch-sensitive display device 100 includes a deformable layer 122 configured to resiliently deform in response to force applied to surface 106. Deformable layer 122 may be comprised of a soft silicone elastomer, urethane elastomer, acrylic film, or any other suitable material, and allows Tx and Rx electrode arrays 108 and 110, and a conductive plane 124 spaced away from (e.g., electrically insulated from) the Tx and Rx electrode arrays, to resiliently deflect relative to one another. As described in further detail below, the resilient deflection of electrode matrix 102 relative to conductive plane 124 may enable a capacitive measurement of applied force.

Touch-sensitive display device 100 includes a display 126 positioned at the bottom of the display device. Display 126 may assume any suitable form (e.g., LCD, OLED, CRT) and may output graphical content for observation by users, which in some examples may be generated based on user input detected with electrode matrix 102. Display 126 may be placed in a shielded position relative to conductive plane 124, which may shield the display from electromagnetic interference originating from electrode matrix 102, and the electrode matrix from electromagnetic interference originating from the display. Conductive plane 124 may cover substantially the entire area of display 126 (e.g., as viewed in a direction normal to surface 106). For examples in which display 126 includes an ITO layer, this ITO layer may be employed as conductive plane 124—e.g., an ITO layer located on the exterior surface of a color filter plate in an LCD display.

Conductive plane 124 may be operable in various electrical states. In particular, FIG. 1 schematically shows a switch 128 coupled to conductive plane 124 that, when closed, couples the conductive plane to a fixed reference voltage V_{ref}, and, when open, disconnects the conductive plane from the reference voltage V_{ref} and allows the conductive plane to float. The fixed reference voltage V_{ref} may be ground or any other suitable reference voltage. Controller 118 may switch, by actuating switch 128, conductive plane 124 between first (e.g., held at V_{ref}) and second (e.g., floating) states while causing Tx electrode driver 116 to drive Tx electrode array 108. In this way, first and second outputs may be received from Rx electrode array 110 (e.g., via receive circuitry 120) that respectively correspond to the first and second states of conductive plane 124. By operating conductive plane 124 in different electrical states, the precision of input sensing may be enhanced relative to merely operating the conductive plane in a single electrical state.

One or both of the first and second electrical states of conductive plane 124 may be used to detect locations of respective touch inputs. For example, controller 118 may measure the mutual capacitance between Tx and Rx electrode arrays 108 and 110 in one or both of the first and second electrical states and compare the measured capacitance(s) to respective baseline values. A location of touch input may be identified in response to detecting that one or both of the mutual capacitances have fallen below their respective baseline values by at least a threshold amount. In some examples, a location of touch input may be identified based on a first output corresponding to the first electrical state without reference to a second output corresponding to the second electrical state.

Both the first and second electrical states of conductive plane 124 may be used to determine a magnitude/pressure of force applied to surface 106. When held at the fixed reference voltage V_{ref} in the first electrical state, conductive plane 124 may increasingly attract electric fields that previously terminated on Rx electrode array 110 (e.g., produced as a result of driving Tx electrode array 108) as electrode matrix 102 approaches the conductive plane in response to applied force. A decreasing mutual capacitance between Tx and Rx electrode arrays 108 and 110 may result. Conversely, the mutual capacitance between Tx and Rx electrode arrays 108 and 110 may increase as electrode matrix 102 approaches conductive plane 124 when the conductive plane is floating in the second electrical state, as additional paths for electrical coupling may be provided in this state. In the second electrical state, a circuit may be formed in which capacitances in touch-sensitive display device 100 are placed in series such that a net mutual capacitance including capacitances among electrode matrix 102 and conductive plane 124 assumes the following form: Cₘ=Cₜₓ_{_}ᵣₓ+Cᵣₓ_{_}_{cp}Cₜₓ_{_}_{cp}/(Cᵣₓ_{_}_{cp}+Cₜₓ_{_}_{cp}), where Cₜₓ_{_}ᵣₓ is the mutual capacitance between Tx and Rx electrode arrays 108 and 110, Cₜₓ_{_}_{cp} is the capacitance between the Tx electrode array and the conductive plane, and Cᵣₓ_{_}_{cp} is the capacitance between the Rx electrode array and the conductive plane.

The opposing changes in mutual capacitance in the first and second electrical states with applied force may be leveraged by combining mutual capacitance measurements in both states to determine a magnitude/pressure of applied force, which may increase the accuracy of force sensing relative to approaches that utilize mutual capacitance measurement in only a single electrical state.

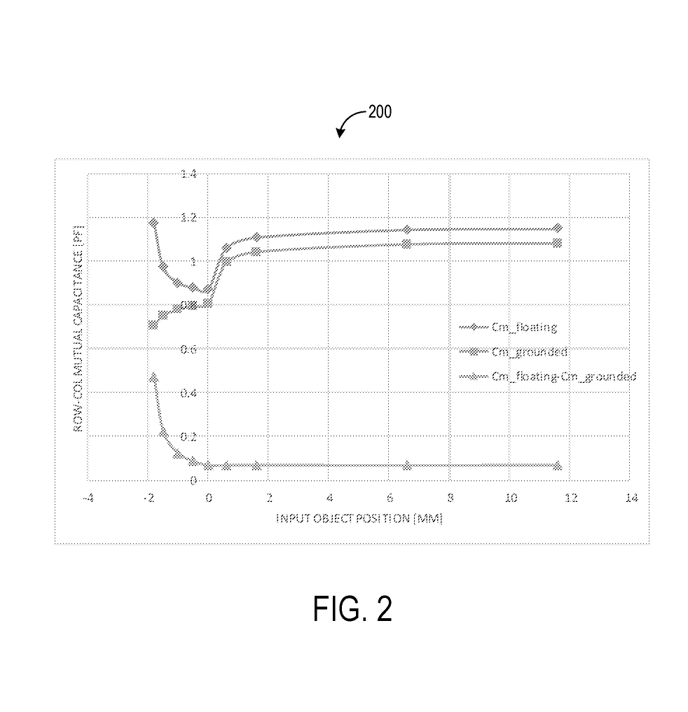

FIG. 2 shows a graph 200 plotting an example dataset illustrating the opposing responses of mutual capacitances measured at electrode matrix 102 with conductive plane 124 in the first and second electrical states. Specifically, graph 200 shows the mutual capacitance (in pF) in electrode matrix 102 with conductive plane 124 in the second electrical state. Mutual capacitance is shown as a function of the position (in mm) of an input object relative to surface 106. This example dataset is represented in FIG. 2 by diamonds and is labeled “Cm_floating”. Input object positions greater than zero represent hover positions above but not in contact with surface 106, with the zero input object position representing an input object in contact with the surface but applying zero or negligible force to the surface, and input object positions less than zero represent an input object in contact with the surface and applying non-negligible force to the surface.

Graph 200 further shows the mutual capacitance in electrode matrix 102 with conductive plane 124 in the first electrical state as a function of the input object position. This example dataset is represented in FIG. 2 by squares and is labeled “Cm_grounded”. As can be seen from these example datasets, the mutual capacitances in the first and second electrical states respond similarly (e.g., decrease with decreasing distance) to hovering input objects but respond dissimilarly as contacting input objects apply increasingly greater force. The mutual capacitance response in the first electrical state may exhibit lower values than that in the second electrical state due to additional decoupling caused by holding conductive plane at V_{ref}, for example. Further, unlike the mutual capacitance response with conductive plane 124 in the first electrical state, the mutual capacitance response with the conductive plane in the second electrical state is non-monotonic. As such, the measurement of mutual capacitance in the second electrical state alone may render differentiating between a hovering input object and a contacting input object applying force ambiguous. While monotonic, the mutual capacitance response in the first electrical state may change slowly with applied force, limiting the resolution of determining the magnitude/pressure of applied force. Accordingly, both mutual capacitance responses in the first and second electrical states may be used to determine the magnitude/pressure of applied force, as, due to their opposing functions, a higher signal-to-noise ratio (SNR) may be achieved than using the response of a single electrical state.

Graph 200 shows the difference between the mutual capacitance responses in the first and second electrical states in the form of a dataset represented in FIG. 2 by triangles and labeled “Cm_floating-Cm_{—}grounded”. As can be seen from this example dataset, the difference between the mutual capacitance responses is monotonic and provides high signal-to-noise ratio (SNR) force sensing that may enable accurate determination of the magnitude/pressure of applied force. Thus, controller 118 may determine a location of a touch input based on first outputs corresponding to conductive plane 124 operating in the first electrical state (and/or based on second outputs corresponding to the second electrical state), and the applied force of the touch input based on both (e.g., the difference between) the first and second outputs respectively corresponding to the conductive plane operating in both the first and second electrical states.

Returning to FIG. 1, in some implementations controller 118 may divide a total duration in which each Tx electrode in a subset (e.g., all Tx electrodes in Tx electrode array 108) of Tx electrodes that are driven in a frame into a first duration in which conductive plane 124 is in the first electrical state and a second duration in which the conductive plane is in the second electrical state. First and second outputs—respectively corresponding to the first and second electrical states of conductive plane 124—may thus be received for each Rx electrode in a subset (e.g., all Rx electrodes in Rx electrode array 110) of Rx electrodes. Accordingly, the presence of touch input and the magnitude/pressure of force applied by touch inputs can be detected for each possible touch location in electrode matrix 102 in a common frame without adding latency. Examples are contemplated, however, in which identified locations of touch input affect measurement of the magnitude/pressure of force applied at the identified locations. The identification of touch input locations may be accompanied by force assessment by dividing Tx electrode excitation periods into first and second durations as described above, in which case touch input location identification may lead to more detailed force assessment in subsequent frames (e.g., by increasing the second duration with or without proportionally decreasing the first duration), or Tx electrode excitation periods may be fully allocated to the first duration for touch input location identification, where, upon identifying touch input locations, at least a portion of the Tx electrode excitation periods are allocated to the second duration for assessing force at the identified locations. Allocating greater durations for force assessment may enable more accurate, faster, and/or higher SNR force sensing.

In view of the above, the first and second durations respectively allocated to touch input location identification and force assessment may be unequal, and may be dynamically varied in response to various input conditions. As an example, relatively greater proportions of the Tx electrode excitation periods may be allocated to the first duration for detecting touch input locations as a greater number of touch input locations are predicted, suspected, and/or detected. Time spent in the second duration for assessing force may be proportionally reduced, as touch input location identification may be initially prioritized and accurate force magnitude/pressure assessment delayed for subsequent frames. As another example, a relatively low number (e.g., one) of touch input locations may be predicted, suspected, and/or detected, and a greater proportion of the Tx electrode excitation periods may be allocated to the second duration relative to the first duration to provide accurate measurement of force magnitude/pressure. Other conditions alternatively or additionally may lead to prioritized force assessment, such as an application running on computing device hardware coupled to touch-sensitive display device 100 stipulating such prioritization (e.g., in which high accuracy force sensing is desired to achieve a user experience), and/or user input stipulating such prioritization.

Switching conductive plane 124 between the first and second electrical states may be leveraged for other purposes such as calibrating the size of a human finger (e.g., finger 112) interacting with touch-sensitive display device 100. As described above with reference to FIG. 2, the mutual capacitance response in the second electrical state increases as force is increasingly applied to surface 106. By comparing mutual capacitance(s) in the second electrical state to one or more previous values, the initial frame in which contact with surface 106 occurred can be determined. The initial frame may be prior to one or more subsequent frames and/or the first frame (e.g., in a given duration) in which contact is detected. In one example, the initial frame may be determined by identifying the frame in which mutual capacitance in the second electrical state reached a minimum value, as relatively higher values may correspond to hovering input objects or non-negligible/non-zero applied force, as can be seen in FIG. 2. The mutual capacitances measured in both the first and second electrical states in this frame can be fed to a predetermined calibration table or function to calculate the size of the human finger, as, for example, mutual capacitance magnitude can be attributed to finger size due to the negligible application of force in this frame. This may enable controller 118 to dynamically select a threshold change in measured capacitance that is interpreted as a touch input, which may enable display device 100 to remain responsive to a variety of finger sizes. A greater degree of responsiveness may thus be afforded relative to approaches in which an average finger size is assumed, as in these approaches, some touch inputs applied by smaller finger sizes may be ignored, leading to a degraded user experience.

Touch-sensitive display device 100 may thus enable touch and force sensing using a common capacitive sensor without increasing sensing latency. As described above, touch input and force may be assessed for each possible touch location in electrode matrix 102, and the variance in human finger size may be accounted for.

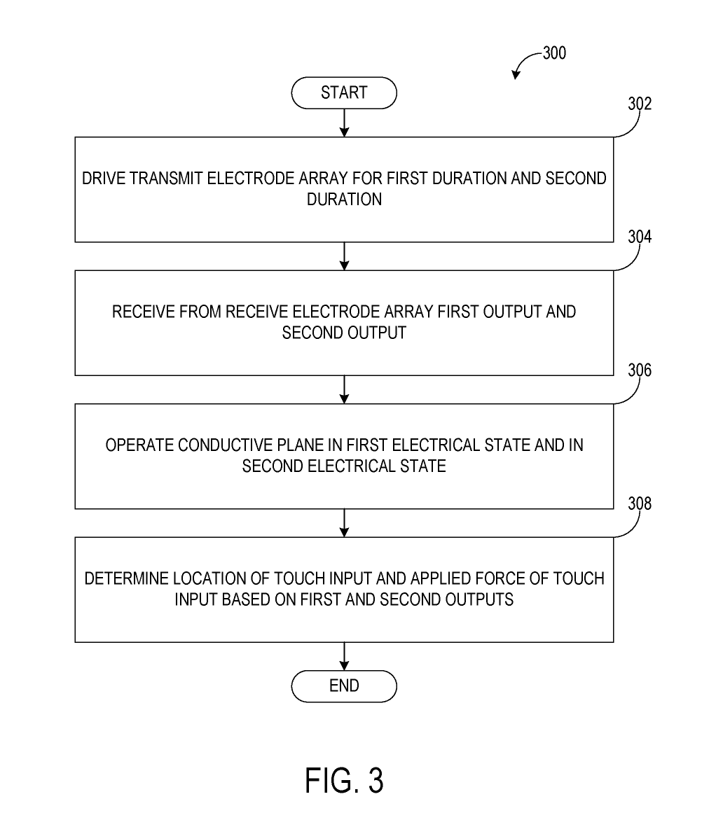

FIG. 3 shows a flowchart illustrating a method 300 of input sensing. Method 300 may be implemented at controller 118 of touch-sensitive display device 100, both of FIG. 1, for example. As such, references to FIG. 1 are made throughout the description of method 300.

At 302, method 300 comprises driving a transmit electrode array for a first duration and for a second duration. The transmit electrode array may be Tx electrode array 108, for example, and may be driven by Tx electrode driver 116. Controller 118 may cause Tx electrode driver 116 to drive Tx electrode array, for example. Driving the transmit electrode array may include driving a plurality or any suitable subset of transmit electrodes of the transmit electrode array, and in some examples all of the transmit electrodes. Driving the transmit electrode array may include applying AC voltage sequences to the driven transmit electrodes.

At 304, method 300 comprises receiving, from a receive electrode array, a first output resulting from driving of the transmit electrode array for the first duration, and a second output resulting from driving of the transmit electrode array for the second duration. The receive electrode array may be Rx electrode array 110, for example, and the first and second outputs may be received by controller 118 via receive circuitry 120, which may comprise current-to-digital and/or other analog-to-digital converters coupled to one or more receive electrodes of the receive electrode array. The receive circuitry may convert received currents into digital codes which are then processed by the controller.

At 306, method 300 comprises operating a conductive plane in a first electrical state during the first duration and in a second electrical state during the second duration. The conductive plane may be spaced away from (e.g., electrically insulated from) the transmit and receive electrode arrays and configured such that the transmit and receive electrode arrays and the conductive plane resiliently deflect relative to one another in response to applied force. A deformable layer such as deformable layer 122 configured to resiliently deform in response to applied force may be positioned between the transmit and receive electrodes and the conductive plane. The conductive plane may be conductive plane 124, for example. In the first electrical state, the conductive plane may be coupled to a fixed reference voltage V_{ref} (e.g., via switch 128), and in the second electrical state, the conductive plane may be disconnected from the reference voltage and allowed to float. As such, the first output may correspond to the conductive plane operating in the first electrical state, and the second output may correspond to the conductive plane operating in the second electrical state.

At 308, method 300 comprises determining a location of a touch input and an applied force of the touch input based on the first and second outputs. The location of the touch input may be determined based on the first output (e.g., without reference to the second output), and the applied force of the touch input may be determined based on both the first and second outputs (e.g., the difference between the first and second outputs). The first and second durations described above may be unequal and may be selected in response to an input condition stipulating prioritization of determination of touch input location or force assessment. For example, the first and second durations may be selected based on the number of locations of respective touch inputs (e.g., that are predicted, suspected, or detected) such that the first duration is greater for a first number of locations than for a second number of locations, and the second duration is less for the first number of locations than for the second number of locations, with the first number being greater than the second number. The second duration may be greater than the first duration, with the first and second durations being selected in response to an input condition (e.g., predicted/suspected/detected low or single number of touch input locations, application context, user input) that stipulates prioritizing assessment of the applied force, for example. The first and second durations may vary among frames, and in some frames, only one of the first and second durations may be employed (e.g., such that the duration employed is extended or not extended, with the non-employed duration omitted). Thus, a total transmit electrode excitation time may remain constant throughout frames or may vary among frames.

Method 300 may include alternative or additional steps not shown in FIG. 3. For example, method 300 may optionally comprise, for examples in which the touch input corresponds to a human finger, determining a size of the finger based on the first and second outputs based on an initial frame in which contact of the finger is detected. In these examples, the size of the finger may be determined based on the first and second outputs collected during the initial frame, where the determination may be carried out during the initial frame (e.g., after collecting the first and second outputs) or during one or more subsequent frames following the initial frame.

In some implementations, the functions performed by a controller (e.g., controller 118 of FIG. 1) described herein, which may include but are not limited to the control of drive circuitry (e.g., Tx electrode driver 116 of FIG. 1) such as the effectuation of drive signal application, reception of output from receive circuitry (e.g., receive circuitry 120 of FIG. 1), and interpretation of the output (e.g., measurement of electrical parameters of the output such as voltage, current, complex impedance, magnitude, phase, determination of capacitance and/or resistance, determination of touch input location and/or applied force), may be implemented in instructions stored in a storage machine (e.g., memory) and that are executable by a logic machine (e.g., processor).

The logic machine may include one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

The storage machine may include one or more physical devices configured to hold instructions executable by the logic machine to implement the methods and processes described herein. When such methods and processes are implemented, the state of the storage machine may be transformed e.g., to hold different data. For example, the instructions may be executable to (1) switch a conductive plane between a first electrical state and a second electrical state while causing a transmit electrode driver to drive a transmit electrode array, (2) receive a first output and a second output from a receive electrode array corresponding respectively to the first and second electrical states, and (3) determine a location of a touch input and an applied force of the touch input based on both the first and second outputs.

The storage machine may include removable and/or built-in devices. The storage machine may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. The storage machine may include volatile, nonvolatile, dynamic, static, read/write, read-only, random-access, sequential-access, location-addressable, file-addressable, and/or content-addressable devices.

It will be appreciated that the storage machine may include one or more physical devices. However, aspects of the instructions described herein alternatively may be propagated by a communication medium (e.g., an electromagnetic signal, an optical signal, etc.) that is not held by a physical device for a finite duration.

Aspects of the logic machine and the storage machine may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of a computing system implemented to perform a particular function. In some cases, a module, program, or engine may be instantiated via the logic machine executing instructions held by storage machine. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, a display subsystem may be used to present a visual representation of data held by the storage machine. This visual representation may take the form of a graphical user interface (GUI). As the herein described methods and processes change the data held by the storage machine, and thus transform the state of the storage machine, the state of the display subsystem may likewise be transformed to visually represent changes in the underlying data. The display subsystem may include one or more display devices (e.g., display 126 of FIG. 1) utilizing virtually any type of technology. Such display devices may be combined with the logic machine and/or the storage machine in a shared enclosure, or such display devices may be peripheral display devices.

When included, an input subsystem may comprise or interface with one or more user-input devices such as a keyboard, mouse, touch screen (e.g., touch-sensitive display device 100 of FIG. 1), or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

The subject matter of the present disclosure is further described in the following paragraphs. One aspect provides a touch-sensitive display device comprising a transmit electrode array, a receive electrode array, a conductive plane configured such that the transmit and receive electrode arrays and the conductive plane resiliently deflect relative to one another in response to applied force, and a controller configured to (1) switch the conductive plane between a first electrical state and a second electrical state while causing a transmit electrode driver to drive the transmit electrode array, (2) receive a first output and a second output from the receive electrode array corresponding respectively to the first and second electrical states, and (3) determine a location of a touch input and an applied force of the touch input based on the first and second outputs. In this aspect, the conductive plane alternatively or additionally may be held at a reference voltage in the first electrical state, and the location of the touch input alternatively or additionally may be determined based on the first output without reference to the second output. In this aspect, the conductive plane alternatively or additionally may be floating in the second electrical state, and the applied force of the touch input alternatively or additionally may be determined based on both the first and second outputs. In this aspect, the first and second outputs corresponding respectively to the first and second electrical states alternatively or additionally may be received for each of a plurality of receive electrodes of the receive electrode array that are scanned in a frame. In this aspect, the controller alternatively or additionally may be configured to switch the conductive plane to the first electrical state for a first duration and to the second electrical state for a second duration. In this aspect, the location of the touch input alternatively or additionally may be one of a number of locations of respective touch inputs, and the controller alternatively or additionally may be configured to select the first and second durations based on the number of locations of respective touch inputs such that the first duration is greater for a first number of locations than for a second number of locations, and the second duration is less for the first number of locations than for the second number of locations, the first number being greater than the second number. In this aspect, the second duration alternatively or additionally may be greater than the first duration, and the controller alternatively or additionally may be configured to select the first and second durations in response to an input condition that stipulates prioritizing assessment of the applied force. In this aspect, the touch input alternatively or additionally may correspond to a finger in contact with the touch-sensitive display device, and the controller alternatively or additionally may be configured to determine a size of the finger based on the first and second outputs at an initial frame in which contact of the finger on the touch-sensitive display device is detected. In this aspect, the touch-sensitive display device alternatively or additionally may comprise a switch that, in the first electrical state, couples the conductive plane to a reference voltage, and in the second electrical state, floats the conductive plane, and the controller alternatively or additionally may be configured to switch the conductive plane between the first and second electrical states by causing actuation of the switch. In this aspect, the touch-sensitive display device alternatively or additionally may comprise a deformable layer between the conductive plane and the transmit and receive electrode arrays, the deformable layer configured to resiliently deform in response to applied force. In this aspect, the touch-sensitive display device alternatively or additionally may comprise receive circuitry coupled to the receive electrode array, the receive circuitry configured to digitize current in the receive electrode array to produce the first and second outputs.

Another aspect provides a method of input sensing comprising driving a transmit electrode array for a first duration and a second duration, receiving, from a receive electrode array, a first output resulting from driving of the transmit electrode array for the first duration, and a second output resulting from driving of the transmit electrode array for the second duration, operating a conductive plane in a first electrical state during the first duration and in a second electrical state during the second duration, the conductive plane configured such that the transmit and receive electrode arrays and the conductive plane resiliently deflect relative to one another in response to applied force, and determining a location of a touch input and an applied force of the touch input based on the first and second outputs. In this aspect, the conductive plane alternatively or additionally may be held at a reference voltage in the first electrical state, and the location of the touch input alternatively or additionally may be determined based on the first output without reference to the second output. In this aspect, the conductive plane alternatively or additionally may be floating in the second electrical state, and the applied force of the touch input alternatively or additionally may be determined based on both the first and second outputs. In this aspect, the location of the touch input alternatively or additionally may be one of a number of locations of respective touch inputs, and the first and second durations alternatively or additionally may be selected based on the number of locations of respective touch inputs such that the first duration is greater for a first number of locations than for a second number of locations, and the second duration is less for the first number of locations than for the second number of locations, the first number being greater than the second number. In this aspect, the second duration alternatively or additionally may be greater than the first duration, and the first and second durations alternatively or additionally may be selected in response to an input condition that stipulates prioritizing assessment of the applied force. In this aspect, the touch input alternatively or additionally may correspond to a finger, and the method alternatively or additionally may comprise determining a size of the finger based on the first and second outputs at an initial frame in which contact of the finger is detected.

Another aspect provides a touch-sensitive display device comprising a transmit electrode array, receive electrode array, a conductive plane configured such that the transmit and receive electrode arrays and the conductive plane resiliently deflect relative to one another in response to applied force, and a controller configured to (1) switch the conductive plane between a first electrical state and a second electrical state while causing a transmit electrode driver to drive the transmit electrode array, (2) receive a first output and a second output from the receive electrode array corresponding respectively to the first and second electrical states, and (3) determine a location of a touch input and an applied force of the touch input based on the first and second outputs, the conductive plane being held at a fixed reference voltage in the first electrical state and floating in the second electrical state. In this aspect, the location of the touch input alternatively or additionally may be determined based on the first output without reference to the second output. In this aspect, the applied force of the touch input alternatively or additionally may be determined based on both the first and second outputs.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A touch-sensitive display device, comprising:
a transmit electrode array;
a receive electrode array;
a conductive plane configured such that the transmit and receive electrode arrays and the conductive plane resiliently deflect relative to one another in response to applied force; and
a controller configured to (1) switch the conductive plane between a first electrical state and a second electrical state while causing a transmit electrode driver to drive the transmit electrode array, (2) receive a first output and a second output from the receive electrode array corresponding respectively to the first and second electrical states, and (3) determine a location of a touch input and an applied force of the touch input based on the first and second outputs.

2. The touch-sensitive display device of claim 1, where the conductive plane is held at a reference voltage in the first electrical state, and where the location of the touch input is determined based on the first output without reference to the second output.

3. The touch-sensitive display device of claim 1, where the conductive plane is floating in the second electrical state, and where the applied force of the touch input is determined based on both the first and second outputs.

4. The touch-sensitive display device of claim 1, where the first and second outputs corresponding respectively to the first and second electrical states are received for each of a plurality of receive electrodes of the receive electrode array that are scanned in a frame.

5. The touch-sensitive display device of claim 1, where the controller is configured to switch the conductive plane to the first electrical state for a first duration and to the second electrical state for a second duration.

6. The touch-sensitive display device of claim 5, where the location of the touch input is one of a number of locations of respective touch inputs, and where the controller is configured to select the first and second durations based on the number of locations of respective touch inputs such that the first duration is greater for a first number of locations than for a second number of locations, and the second duration is less for the first number of locations than for the second number of locations, the first number being greater than the second number.

7. The touch-sensitive display device of claim 5, where the second duration is greater than the first duration, and where the controller is configured to select the first and second durations in response to an input condition that stipulates prioritizing assessment of the applied force.

8. The touch-sensitive display device of claim 1, where the touch input corresponds to a finger in contact with the touch-sensitive display device, and where the controller is configured to determine a size of the finger based on the first and second outputs at an initial frame in which contact of the finger on the touch-sensitive display device is detected.

9. The touch-sensitive display device of claim 1, further comprising a switch that, in the first electrical state, couples the conductive plane to a reference voltage, and in the second electrical state, floats the conductive plane, where the controller is configured to switch the conductive plane between the first and second electrical states by causing actuation of the switch.

10. The touch-sensitive display device of claim 1, further comprising a deformable layer between the conductive plane and the transmit and receive electrode arrays, the deformable layer configured to resiliently deform in response to applied force.

11. The touch-sensitive display device of claim 1, further comprising receive circuitry coupled to the receive electrode array, the receive circuitry configured to digitize current in the receive electrode array to produce the first and second outputs.

12. A method of input sensing, comprising:
driving a transmit electrode array for a first duration and a second duration;
receiving, from a receive electrode array, a first output resulting from driving of the transmit electrode array for the first duration, and a second output resulting from driving of the transmit electrode array for the second duration;
operating a conductive plane in a first electrical state during the first duration and in a second electrical state during the second duration, the conductive plane configured such that the transmit and receive electrode arrays and the conductive plane resiliently deflect relative to one another in response to applied force; and
determining a location of a touch input and an applied force of the touch input based on the first and second outputs.

13. The method of claim 12, where the conductive plane is held at a reference voltage in the first electrical state, and where the location of the touch input is determined based on the first output without reference to the second output.

14. The method of claim 12, where the conductive plane is floating in the second electrical state, and where the applied force of the touch input is determined based on both the first and second outputs.

15. The method of claim 12, where the location of the touch input is one of a number of locations of respective touch inputs, and where the first and second durations are selected based on the number of locations of respective touch inputs such that the first duration is greater for a first number of locations than for a second number of locations, and the second duration is less for the first number of locations than for the second number of locations, the first number being greater than the second number.

16. The method of claim 12, where the second duration is greater than the first duration, and where the first and second durations are selected in response to an input condition that stipulates prioritizing assessment of the applied force.

17. The method of claim 12, where the touch input corresponds to a finger, the method further comprising determining a size of the finger based on the first and second outputs at an initial frame in which contact of the finger is detected.

18. A touch-sensitive display device, comprising:
a transmit electrode array;
a receive electrode array;
a conductive plane configured such that the transmit and receive electrode arrays and the conductive plane resiliently deflect relative to one another in response to applied force; and
a controller configured to (1) switch the conductive plane between a first electrical state and a second electrical state while causing a transmit electrode driver to drive the transmit electrode array, (2) receive a first output and a second output from the receive electrode array corresponding respectively to the first and second electrical states, and (3) determine a location of a touch input and an applied force of the touch input based on the first and second outputs, the conductive plane being held at a fixed reference voltage in the first electrical state and floating in the second electrical state.

19. The touch-sensitive display device of claim 18, where the location of the touch input is determined based on the first output without reference to the second output.

20. The touch-sensitive display device of claim 18, where the applied force of the touch input is determined based on both the first and second outputs.
